(19) United States
(12) Patent Application Publication
(10) Pub. No.: US 2006/0121616 A1
(43) Pub. Date: Jun. 8, 2006

(54) Method and system for increasing efficiency of FGD operation in fossil fuel boilers

(75) Inventors: W. Curt Lefebvre, Boston, MA (US); Daniel W. Kohn, Cambridge, MA (US)

Correspondence Address: WILMER CUTLER PICKERING HALE AND DORR LLP, 60 STATE STREET, BOSTON, MA, 02109, US

(73) Assignee: NeuCo, Inc., Boston, MA (US)

(21) Appl. No.: 11/233,891

(22) Filed: Sep. 23, 2005

Related U.S. Application Data
(60) Provisional application No. 60/612,868, filed on Sep. 24, 2004.

(51) Int. Cl. G05D 21/00

(52) U.S. Cl. 436/55

(57) ABSTRACT

A method and system are provided for determining operating settings for an FGD unit in a boiler. The method includes receiving a performance objective for the FGD unit, receiving data indicating a current state of the FGD unit, using a controller to determine operating settings for the FGD unit to satisfy the performance objective for the FGD unit, and outputting the operating settings to the FGD unit.

### RELATED APPLICATION

The present application is based on and claims priority from U.S. Patent Application Ser. No. 60/612,868 filed on Sep. 24, 2004 entitled “Method And System For FGD Optimization,” which is incorporated by reference herein in its entirety.

### FIELD OF THE INVENTION

The present invention relates generally to increasing the efficiency and effectiveness of fossil fuel boilers and, more particularly, to improving Flue Gas Desulfurization (FGD) operation in fossil fuel boilers.

### BACKGROUND OF THE INVENTION

The combustion of coal and other fossil fuels during the production of steam or power produces dozens of gaseous oxides, such as NO, NO₂, N₂O, H₂O, HO, O₂H, CO, CO₂, SO, SO₂, SO₃, etc. which together, with N₂ and excess O₂, constitute the overwhelming majority of the boiler flue gas. Many of these species, such as SO, OH, and O₂H are highly reactive and are chemically quenched prior to the flue gas exit from the boiler stack. Some of the species, such as CO, CO₂, and H₂O are highly stable, the vast majority of which will pass unreacted out of the boiler stack. Still other species, such as SO₂, SO₃, NO, and NO₂ are moderately reactive. These moderately reactive species are subject to removal from the flue gas by chemical reaction processes, and are also subject to complex variability.

SO, SO₂, and SO₃, together referred to as SOx, are gases that are highly toxic to humans. SOx can combine with H₂O in the lungs and other mucosal membranes to form toxic sulfuric acid. In addition, SOx can combine with H₂O or HOx gases in the flue gas or in the lower troposphere to form sulfuric acid, which is then subject to long range transport. For these and other reasons, including federal and state legislation, many industrial power plants seek to find ways to cost effectively reduce the flue gas SOx to acceptable emission levels.

The weight percentage of sulfur in coal varies greatly. The terms low sulfur and high sulfur coal generally refer to sulfur contents less than 0.5% w/w and greater than 2.0% w/w, respectively, though some high sulfur coals contain greater than 5.0% w/w. The sulfur in coal comes from either inorganic or organic (carbon bound) sources. The principle inorganic constituent is Pyrite, FeS₂. There are a large variety of aromatic and aliphatic organic sulfurs in coal. Natural gas contains very low levels of Sulfur. Oils, like coal, range in sulfur content from less than 0.5% w/w to greater than 2% w/w. Other fuel sources, such as petcoke, rubber, and paper and plastic waste, have variable sulfur content.

At typical furnace exit gas temperatures, approximately 2000 degrees Fahrenheit, nearly all sulfur is converted into SO₂. SO concentrations are negligible and SO₃ concentrations are approximately 0.1% of the SO₂ concentration. For low and high sulfur coal respectively, SO₂ concentrations range from approximately less than 250 ppm to greater than 1000 ppm at the furnace exit.

In the absence of FGD, SO₂ and SO₃ concentrations will change throughout the duct of the boiler, largely as a function of temperature and the concentration of other gaseous and particulate chemical and physical species. The mole fraction of SO₃ to SO₂ increases from about 0.1% to as high as about 0.7% as temperatures drop from about 1900 to less than 1300 degrees Fahrenheit along the duct. The mole fraction does not change appreciably as flue gas temperatures drop below 1300 degrees Fahrenheit. The ratio is determined in part by the concentration of O₂ in the flue gas. Other factors can impact the mole ratio of SO₂ and SO₃. In particular, the catalyst that is used in Selective Catalytic Reduction (SCR) devices to reduce NOx into N₂ and water, also oxidizes SO₂ into SO₃. The conversion rate is dependent on many factors, including coal type, amount of catalyst present, catalyst additives, SCR design, etc., but generally ranges from about 0.5-4%. Both SO₂ and SO₃ can react with other chemical species. Chief among these reactions are those with ammonia and water that lead to the formation of ammonium sulfate and ammonium sulfite, which tend to stick to the boiler duct surfaces.

Desirable emission levels vary, depending upon many factors including plant location, stack height, furnace SOx levels, and state laws and provisions. Desirable emission levels may be expressed as an absolute number, e.g. less than 50 ppm, or as a percentage reduction from the furnace SO₂ levels. Desirable SO₂ emission levels are typically in the hundreds of ppm, while desirable SO₃ emission levels are typically below 8 ppm. SO₃ emissions are particularly problematic because SO₃ is visible as a blue gas at concentrations exceeding about 10 ppm. Further, the reaction of SO₃ with water to form H₂SO₄ (sulfuric acid) is relatively fast and non-reversible. As a result, SO₃ can produce sulfuric acid aerosols and fallout within the immediate proximity of the emission.

A number of technologies have been adapted by industrial power plants in order to reduce furnace SOx levels to acceptable emission levels. FGDs can be classified as wet scrubbers and dry scrubbers. All wet FGDs utilize the passage of sulfur-containing flue gas through an aqueous solution or spray in order to drive the capture of SOx by reaction with dissolved reagents inside the aqueous vat. Sediments of gypsum (CaSO₄) are then separated from the water and other materials, where they may be further purified and/or sold. Wet FGDs include Limestone Scrubbing with Forced Oxidation (LSFO), Lime Scrubbing with Magnesium-Enhanced Lime (MEL), and others. Dry FGDs differ in that they result in relatively dry reactants that do not need to be mechanically or chemically further separated from an aqueous vat. The spray dryer FGD, for instance, utilizes nearly saturated aqueous dissolved hydrated lime (Ca(OH)₂) sprayed into the flue gas flow. SO₂ reacts on the drying hydrated lime particle surfaces, producing dry gypsum, which is collected at the bottom of the spray tank or in a downstream ElectroStatic Precipitator (ESP). Dry FGDs include Lime Scrubbing with Spray-Dryer absorber, Lime Scrubbing with Circulating fluidized bed (CFB) absorber, and others.

Other technologies, such as Wet Electrostatic Precipitators (WESP) have been adapted from other applications to remove certain sulfur particles and gaseous SO₃ or H₂SO₄ droplets. Other sulfur removal technologies include the use of coal additives or the blending of low sulfur coal with cheaper high sulfur coal.

Each of the FGD processes and associated hardware has particular design objectives, removal efficiencies, and associated costs. Wet and dry FGD technologies can remove approximately 98% and 90-95% of flue gas SO₂ respectively. Approximately 85% of the coal fired boilers in the United States use wet FGD scrubbers. Dry FGD scrubbers are used primarily where flue gas SO₂ concentrations out of the furnace are relatively low. Dry FGD scrubbers that use dry powder (sodium bicarbonate, sodium carbonate) injection remove only 50-70% of the sulfur, but are used at only a few sites in the United States.

The wet FGD has the highest adoption rate in the United States. But given the high efficiency of the wet FGD technology, there is relatively little additional sulfur to be removed from optimization of the desulfurization process itself. However, the process does consume both energy and CaCO₃. Many wet FGDs are designed with a significant number of manipulatable levers in order to provide load-based flexibility. Some FGDs operate at non-design flue gas input rates by having variable control over reagent slurry spray volume. In some of these FGDs, the number of pumps in service provides control of the slurry spray volume at any time. In some other FGDs, the variable control on individual pumps provides control of the slurry spray volume. In some FGDs, fans are used to push O₂ into the slurry mixture in order to drive the conversion of CaSO₃ into CaSO₄ (gypsum). One common configuration is to have 5 (+1 standby) pumps and 2 fans.

The power consumption of the FGD is significant. A typical fan or pump might, e.g., consume about 1 MW for operation, at a nominal cost of ˜$100/hr. Typical plant heat rates are 10,000 BTU/kwh and since a low average bituminous coal contains about 10,000 BTU/lb, it takes about 1 lb of coal to produce 1 kwh, or 1,000 lbs of coal to produce 1 MWh.

The amount of sulfur that is released from fossil fuel combustion can be calculated. Since a high sulfur coal is about 3% Sulfur by weight, combustion of 1,000 lbs of this coal to produce 1 MWh of power will generate 30 lbs of elemental Sulfur (about 60 lbs of SO₂ gas) as a byproduct. In order to remove that SO₂ and trap it as gypsum, about 95 lbs of limestone are required and up to 128 lbs of gypsum are produced. For a base loaded 500 MW unit over a 24 hour period, this indicates 570 tons of limestone are consumed at a cost of $8600, producing 768 tons of gypsum at a resale value of $3100.

Annually, at 100% capacity factor, such a unit consumes $3.1 Million in limestone and sells up to $1.1 Million in gypsum. If such an FGD has two fans and six pumps, the total parasitic electricity cost of the FGD is about $19 k/day or $6.9 Million/year, consuming about 1% of the plant's energy production. For such a plant, a 10% conversion efficiency improvement could save $300 K/year in limestone costs and the removal of one recirculation pump would save up to $862 K/year.

There are many other variables, some of which are manipulatable, which contribute to the cost and benefit of the FGD. Some are already well controlled, such as the amount of limestone that is fed into the slurry, through a limestone (CaCO₃) output measurement and a feedback controller. The automated limestone controller typically will utilize measurements of inlet SO₂ concentration, flue gas throughput, and reaction tank pH in order to feed forward a limestone injection rate. The feedback loop of the controller will compare the desired outlet SO₂ concentration with the actual measured outlet SO₂ concentration and will adjust the inlet limestone concentration accordingly.

Despite the available fully automated control of limestone introduction to the wet FGD, the complete relationship between current limestone introduction rate and slurry density, slurry pH, slurry liquid level, differential pressure across plugged Bulk Entrainment Separators and Chevron Vanes, absorber spray line pressures, load, and sulfur removal is extremely complex. Despite the automation, the most skilled and unskilled control room operators can systematically differ by 20% in the average limestone usage during their shifts. Because the limestone expense is frequently the second largest single expense in a power plant (fuel being the first), a small percentage saving of limestone requirement has a large value. In the example calculation above, a 10% reduction of limestone would save $300K per year.

The optimal SO₂ removal efficiency, for a specified and fixed amount of SO₂ removed, will use the least amount of limestone. The controllable levers that impact the efficiency of SO₂ removal include the pH of the slurry (largely determined by the concentration of limestone), the density of the slurry (determined by the amount of water and particulate in the holding tank), the ability to bias flue gas flow between multiple scrubber modules by biasing ID fans or other gas flow controls (the differential pressure across plugged Bulk Entrainment Separators and Chevron Vanes), current limestone introduction rate, absorber spray line pressures, and Sulfur load. Typical automated controls adjust the setpoint of a manipulated variable, such as limestone flow. Improvement of SO₂ removal efficiency may be gained by adjusting the limestone setpoint itself or, more commonly, adjusting a limestone bias, which is outside of the previously described automated DCS feed forward and feed back loops controlling limestone injection.

Wet FGD removes SO₂ from flue gas by adding limestone (CaCO₃) to the flue gas. The limestone is either present in aqueous liquid or aqueous aerosol. Because the FGD is designed so that no significant amount of these forms of limestone can be permanently entrained in the flue gas, the limestone may cycle through the reaction tank back into the flue gas multiple times until it reacts with the SO₂. There are a number of chemical reaction steps involved in the complete removal of SO₂. Each step is governed by a set of chemical equilibria that may be used to accelerate the reactions and control the equilibrium species concentration. The first reaction is the solvation of the gaseous SO₂ molecule into the aqueous limestone spray. In this step, SO₂ is hydrated to form H₂SO₃, sulfurous acid.
SO₂+H₂O→H₂SO₃ Eq. 1

Some of this sulfurous acid can be converted directly to sulfuric acid (sulfate ion) via oxidation from O₂ molecules found in the flue gas in the presence of water.
2H₂SO₃+O₂+4H₂O→4H₂O+2H₂SO₄ Eq. 2

The sulfuric acid is actually present as Hydrogen ions (H+) and Sulfate ions (SO₄—) due to the basic conditions provided by the limestone. The sulfate ions then combine with the Calcium ion from the limestone to form calcium sulfate, CaSO₄ (gypsum), which precipitates out of solution. The precipitation of gypsum drives reaction 2 to create more gypsum from any available sulfurous acid and oxygen. Under the basic conditions created by the limestone, the sulfurous acid may also combine with solvated calcium to form CaSO₃ (calcium sulfite).

One challenge of FGD optimization is to adjust the limestone and gas circulation parameters so as to maintain high desulfurization effectiveness while enhancing both desulfurization and process efficiency. Desulfurization efficiency may include the efficiencies of reactions 1 and 2 in the spray region. The efficiency of reaction in the spray region is related to temperature, O₂ concentration, limestone concentration, droplet size and distribution, pH, spray backing pressure, flue gas residence time and velocity, and SO₂ concentration. Desulfurization efficiency may also include the efficiencies of reactions 1 and 2 in the reaction tank. The efficiency of reaction in the tank is related to its temperature profile, O₂ concentration profile, limestone concentration profile, and pH profile. Process efficiencies include the spray pump duty, flue gas fan duty, reaction tank mixer duty, and washer lance duty (for cleaning Bulk Entrainment Separators and Chevron Vanes). Efficiency may also include the ability to generally minimize or reduce the variety and degrees of limestone side reactions. Limestone side reactions have two costs, the first being that of the limestone itself and the second being that required to purify the gypsum of the resulting contaminants. In addition to actual chemical reactions, the removal of unused limestone by continuous draining of the slurry, may also be considered a limestone side reaction because it uses up limestone without producing gypsum. Desulfurization effectiveness is typically prescribed in terms of allowable SO₂ emission level(s) to which a plant must adhere.

### BRIEF SUMMARY OF EMBODIMENTS OF THE INVENTION

Briefly, in accordance with one or more embodiments of the invention, a method and system are provided for determining operating settings for an FGD unit in a boiler. The method includes receiving a performance objective for the FGD unit, receiving data indicating a current state of the FGD unit, using a controller to determine operating settings for the FGD unit to satisfy the performance objective for the FGD unit, and outputting the operating settings to the FGD unit.

Various embodiments of the invention are directed to methods and systems for improving the operating efficiency of fossil fuel boilers by generally optimizing the limestone introduction used in the desulfurization of flue gas by removal of SO₂. One or more embodiments of the present invention include methods and systems for determining and effecting wet FGD controllable parameters such as pH, density, tank level, flue gas pressures and/or operating settings such as limestone feeder speed or reaction tank water inlet speed.

In accordance with one or more embodiments of the invention, FGD performance goals, such as SO₂ emission levels, are used to determine controllable parameter and/or operating settings. One aspect of the present invention includes using an indirect controller that uses a system model of the FGD that relates controllable parameters in the FGD to the performance of the FGD. The indirect controller can additionally implement a strategy to achieve the desired controllable parameters. The system model predicts the performance of the FGD. The primary performance parameter may be, e.g., limestone or FGD power consumption. In some embodiments of the invention, in operation, the inputs to the system model are current controllable parameter conditions and FGD operating conditions, and the outputs of the model are predicted FGD performance values. In some embodiments of the invention, the system model may be, e.g., a neural network or a mass-energy balance model or a genetically programmed model. The model may be developed using actual historical or real-time performance data from operation of the unit. In various embodiments, the performance objectives may be specified in different ways. For example, the controller may be directed to generally minimize the limestone consumption, or to maintain the limestone consumption below a maximum acceptable value.

In accordance with one or more embodiments of the invention, the system model may be, e.g., a neural network or a mass-energy balance model or a genetically programmed model. The model may be developed using actual historical or real-time performance data from operation of the unit. The performance objectives may be specified in different ways. For example, the controller may be directed to reduce or generally minimize the SOx emission levels, or to reduce or generally minimize the heat rate while maintaining an acceptable SOx emission level.

In accordance with one or more further embodiments of the invention, a mist eliminator optimization subsystem may be provided that is designed to maintain cleanliness levels of the Chevron Vanes and Bulk Entrainment Separators. An indirect controller may use the system model to specify the desired cleanliness levels and then communicate them to the mist eliminator optimization subsystem, e.g., to attain the FGD's performance goals or to improve or generally maximize the FGD's performance. In another aspect of the invention, a mist eliminator optimization subsystem can include an indirect controller that adjusts the operating settings of mist eliminators based on target cleanliness factors.

In accordance with one or more further embodiments of the invention, an FGD optimization subsystem of a boiler optimization system is provided to maintain control of the FGD performance objectives consistent with the boiler performance objectives such as, e.g., reduction of heat rate. An indirect controller may use the boiler system model to specify the desired FGD performance goals and/or control parameters and then communicate them to the FGD optimization subsystem, e.g., to attain the FGD's performance goals or to improve or generally maximize the FGD's performance. In another aspect of the invention, an FGD optimization subsystem can include an indirect controller that adjusts the operating settings of the FGD based on target control parameters.

In another aspect of the invention, an indirect controller is provided that uses an FGD system model to adjust directly the FGD operating parameters to satisfy the performance objectives. In certain embodiments of the invention, the system model relates the FGD operating parameters to the performance of the FGD.

In accordance with one or more further embodiments of the invention, a direct controller determines desired control parameter levels in the FGD as a function of the performance of the FGD, without using a system model of the FGD. In some embodiments of the invention, in operation, the inputs to the direct controller are current control parameter conditions and FGD operating conditions and performance goals, and the outputs of the model are desired control parameters. In another aspect of the invention, the direct controller relates FGD operating parameters to the performance of the FGD and adjusts the FGD operating parameters directly. The direct controller may be a neural controller, i.e., it may be implemented as a neural network. In some embodiments, evolutionary programming is used to construct, train, and provide subsequent adaptation of the direct controller. In some embodiments reinforcement learning is used to construct, train, and provide subsequent adaptation of the controller. The direct controller may be developed using actual historical or real-time performance data from operation of the unit.

In another aspect of the invention, in embodiments including an FGD optimization subsystem, a direct controller can adjust the desired performance objective for the FGD and transmit them to the FGD optimization subsystem (without the assistance of a system model) to attain the unit's performance goals.

In one or more embodiments of the invention, the direct or indirect controller is adaptive. The controller or system model can be retrained periodically or as needed in order to maintain the effectiveness of the controller over time.

One advantage of one or more embodiments of the invention is that FGD control parameter levels can be determined in terms of the performance of the FGD, eliminating the need to determine and enter target control parameter levels separately. Another advantage of one or more embodiments of the invention is that control parameter levels for different subsystems in the FGD can be determined comprehensively and coordinated. Another advantage of one or more embodiments of the invention is that FGD operating parameters can be determined in terms of the performance of the FGD, eliminating the need to determine desired control parameter levels separately. Another advantage of one or more embodiments of the invention is that FGD operating parameters can be determined in terms of the performance of the boiler, eliminating the need to determine desired FGD control parameters separately.

These and other features and advantages of the present invention will become readily apparent from the following detailed description, wherein embodiments of the invention are shown and described by way of illustration of the best mode of the invention. As will be realized, the invention is capable of other and different embodiments and its several details may be capable of modifications in various respects, all without departing from the invention. Accordingly, the drawings and description are to be regarded as illustrative in nature and not in a restrictive or limiting sense, with the scope of the application being indicated in the claims.

### BRIEF DESCRIPTION OF THE DRAWINGS

FIG. 1 is a block diagram illustrating an FGD control system in accordance with one or more embodiments of the invention.

### DETAILED DESCRIPTION OF THE PREFERRED EMBODIMENTS

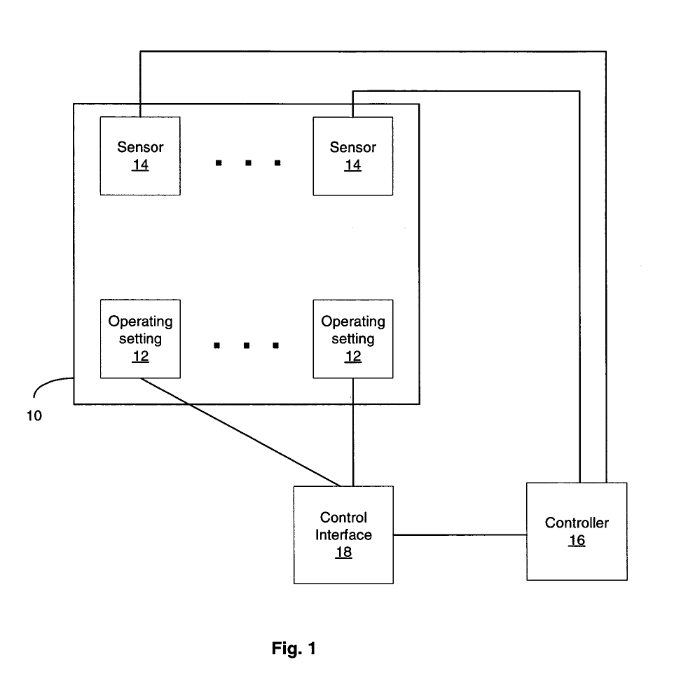

FIG. 1 is a block diagram of an FGD control system used in a fossil fuel boiler in accordance with one or more embodiments of the invention. An FGD unit 10 can include a plurality of subsystems, each of which can separately be monitored for chemical (e.g., pH) and physical states (e.g., pressure, temperature, density, fluid level, etc.) In order to affect changes to the control parameters of each subsystem, each subsystem includes one or more operating settings 12 such as, e.g., limestone injector settings, mist eliminator wash lance settings, ID fan settings, tank water level settings, tank mixer settings, tank recycle spray pump settings, etc. Each FGD subsystem also includes one or more sensors 14 that measure one or more properties indicative of the value of any chemical or physical attributes of concern. The data collected by the sensors 14 is useful both for timing operations and for determining the effectiveness and necessary extent operations. The boiler includes an FGD optimization system, including a controller 16 that configures an FGD control interface 18, which is in communication with the operating settings 12. The FGD optimization system adjusts the FGD operating settings 12 according to desired FGD or boiler performance goals using the controller 16. As discussed below, in various embodiments, the controller 16 may be either a direct controller (i.e., one that does not use a system model) or an indirect controller (i.e., one that uses a system model). In embodiments in which the FGD subsystem incorporates a direct controller, it executes and optionally adapts (if it is adaptive) a control law that drives the FGD toward the FGD or boiler performance goals. Direct control schemes in various embodiments of the invention include, e.g., a table or database lookup of control variable settings as a function of the process state, and also include a variety of other systems, involving multiple algorithms, architectures, and adaptation methodologies. In one or more embodiments, a direct controller is implemented in a single phase.

The controller may be a steady state or dynamic controller. A physical plant, such as boiler or an FGD unit, is a dynamic system, i.e., it is composed of materials that have response times due to applied mechanical, chemical, and other forces. Changes made to control variables or to the state of the boiler or the FGD are, therefore, usually accompanied by oscillations or other movements that reflect the fast time-dependent nature and coupling of the variables. During steady state operation or control, an FGD and/or a boiler reaches an equilibrium state such that a certain set or sets of control variable settings enable maintenance of a fixed and stable plant output of a variable such as megawatt power production. Typically, however, the boiler or FGD operates and is controlled in a dynamic mode. During dynamic operation or control, the boiler or the FGD is driven to achieve an output that differs from its current value. In certain embodiments, the controller is a dynamic controller. In general, dynamic controllers include information about the trajectory nature of the plant states and variables. In some embodiments, the controller may also be a steady-state controller used to control a dynamic operation, in which case the dynamic aspects of the plant are ignored in the control and there is a certain lag time expected for the plant to settle to steady state after the initial process control movements.

In accordance with one or more embodiments of the invention, three general classes of modeling methods are contemplated to be useful for the construction of direct controller. One method is a strictly deductive, or predefined, method. A strictly deductive method uses a deductive architecture and a deductive parameter set. Examples of deductive architectures that use deductive parameter sets include parametric models with preset parameters such as first principle or other system of equations. Other strictly deductive methods include preset control logic such as if-then-else statements, decision trees, or lookup tables whose logic, structure, and values do not change over time.

It is preferred that the controller be adaptive, to capture the off-design or time-varying nature of the FGD and the boiler. A parametric adaptive modeling method may also be used in various embodiments of the invention. In parametric adaptive modeling methods, the architecture of the model or controller is deductive and the parameters are adaptive, i.e., are capable of changing over time in order to suit the particular needs of the control system. Examples of parametric adaptive modeling methods that can be used in some embodiments of the invention include regressions and neural networks. Neural networks are contemplated to be particularly advantageous for use in complex nonlinear plants, such as the FGD and the boiler. Many varieties of neural networks, incorporating a variety of methods of adaptation, can be used in embodiments of the present invention.

A third type of modeling method, strictly non-parametric, that can also be used utilizes an adaptive architecture and adaptive parameters. A strictly non-parametric method has no predefined architecture or sets of parameters or parameter values. One form of strictly non-parametric modeling suitable for use is evolutionary (or genetic) programming. Evolutionary programming involves the use of genetic algorithms to adapt both the model architecture and its parameters. Evolutionary programming uses random, but successful, combinations of any set of mathematical or logical operations to describe the control laws of a process.

In embodiments in which controller is adaptive, it is preferably implemented on-line, or in a fully automated fashion that does not require human intervention. The particular adaptation methods that are applied are, in part, dependent upon the architecture and types of parameters of the controller. The adaptation methods used in various embodiments of the invention can incorporate a variety of types of cost functions, including supervised cost functions, unsupervised cost function and reinforcement based cost functions. Supervised cost functions include explicit FGD output data in the cost function, resulting in a model that maps any set of FGD input and state variables to the corresponding FGD output. Unsupervised cost functions require that no plant output data be used within the cost function. Unsupervised adaptation is primarily for cluster or distribution analysis.

In one or more embodiments of the invention, a direct controller may be constructed and subsequently adapted using a reinforcement generator, which executes the logic from which the controller is constructed. Reinforcement adaptation does not utilize the same set of performance target variable data of supervised cost functions, but uses a highly restricted set of target variable data, such as ranges of what is desirable or what is bad for the performance of the FGD. Reinforcement adaptation involves training the controller on acceptable and unacceptable FGD operating conditions and FGD outputs. Reinforcement adaptation therefore enables controller to map specific plant input data to satisfaction of specific goals for the operation of the FGD and/or the boiler.

Various embodiments of the invention can use a variety of search rules that decide which of a large number of possible permutations should be calculated and compared to see if they result in an improved cost function output during training or adaptation of the model. The search rule used may be a zero-order, first-order or second-order rule, including combinations thereof. It is preferred that the search rule be computationally efficient for the type of model being used and result in global optimization of the cost function, as opposed to mere local optimization. A zero-order search algorithm does not use derivative information and may be preferred when the search space is relatively small. One example of a zero-order search algorithm useful in embodiments of the invention is a genetic algorithm that applies genetic operators such as mutation and crossover to evolve best solutions from a population of available solutions. After each generation of genetic operator, the cost function may be reevaluated and the system investigated to determine whether optimization criteria have been met. While the genetic algorithms may be used as search rules to adapt any type of model parameters, they are typically used in evolutionary programming for non-parametric modeling.

A first-order search uses first-order model derivative information to move model parameter values in a concerted fashion towards the extrema by simply moving along the gradient or steepest portion of the cost function surface. First-order search algorithms are prone to rapid convergence towards local extrema and it is generally preferable to combine a first-order algorithm with other search methods to ensure a measure of global certainty. In some embodiments of the present invention, first-order searching is used in neural network implementation. A second-order search algorithm utilizes zero, first, and second-order derivative information.

In one or more embodiments of the invention, the controller is generated in accordance with the operating variables available for manipulation and the types of FGD performance objectives defined for the FGD. Operating variables can be directly manipulated in order to achieve the control objectives, e.g., reduce SO₂ output. The SO₂ output or limestone consumption may be the primary performance factor that the FGD optimization system is designed to regulate. Desired objectives for the performance parameters may be entered into the controller, such as by an operator, or may be built into the controller. The desired objectives may include specific values, e.g., for emissions, or more general objectives, e.g., minimizing a particular performance parameter or maintaining a particular range for a parameter. Selecting values or general objectives for performance parameters may be significantly easier initially than determining the corresponding FGD operating settings for attaining those performance values. Desired values or objectives for performance parameters are generally known beforehand, and may be dictated by external requirements. For example, for the SO₂ output, a specific maximum acceptable level may be provided to the controller, or the controller may be instructed to minimize the SO₂.

In exemplary embodiments, the controller is formed of a neural network, using a reinforcement generator to initially learn and subsequently adapt to the changing relationships between the control variables, in particular, the FGD operating parameters, and the acceptable and unacceptable overall objectives for the boiler and the FGD. The rules incorporated in the reinforcement generator may be defined by a human expert, for example. The reinforcement generator identifies the FGD conditions as favorable or unfavorable according to pre-specified rules, which include data values such as SO₂ emission thresholds, limestone consumption rate thresholds, mist eliminator wash lance water consumption thresholds, current plant load, etc. For example, the reinforcement generator identifies a set of FGD operating parameters as part of a vector that contains the favorable-unfavorable FGD objective data, for a single point in time. This vector is provided by the reinforcement generator to controller to be used as training data for the neural network. The training teaches the neural network to identify the relationship between any combination of FGD operating parameters and corresponding favorable or unfavorable FGD conditions. In a preferred embodiment, controller further includes an algorithm to identify the preferred values of FGD operating parameters, given the current values of FGD operating parameters, as well as a corresponding control sequence. In certain contemplated embodiments, the algorithm involves identifying the closest favorable FGD operating region to the current region and determining the specific adjustments to the FGD operating parameters that are required to move the FGD to that operating region. Multiple step-wise FGD operating parameter adjustments may be required to attain the closest favorable FGD objective region due to rules regarding FGD operating parameter allowable step-size or other constraints.

Additional methods for controlling FGDs are described. In an initial step, the controller obtains a performance goal. For example, the goal may be to prioritize maintaining the SO₂ output of FGD in a favorable range. In a subsequent step, the controller checks the present SO₂ output, which may be sensed by a performance monitoring system. If the SO₂ output is already favorable, controller maintains the present control state or executes a control step from a previously determined control sequence until a new goal is received or the plant output is checked again. If the SO₂ output is not favorable, in subsequent step, the controller identifies the closest control variable region allowing for favorable SO₂. In one contemplated embodiment, the closest favorable boiler objective region is identified by an analysis of the FGD objective surface of the neural network of controller. The FGD objective surface is a function, in part, of the current FGD operating conditions. In certain embodiments, the algorithm sweeps out a circle of radius, r, about the point of current FGD operating settings. The radius may be calculated as the square root of the quantity that is the sum of the squares of the distance between the current setting of each FGD parameter value and the setting of the proposed FGD parameter value. In particular,
Radius²=Σᵢ^{N}αᵢ(S.P²_{i-proposed}−S.P²_{i-current})²

For each i^{th} FGD parameter, up to FGD parameter number N, with normalization coefficients αᵢ. The sweep looks to identify a point on the boiler objective surface with a favorable value. If one is found in the first sweep, the radius is reduced, and the sweep repeated until the shortest distance (smallest radius) point has been identified. If a favorable plant objective surface point is not found upon the first sweep of radius r, then the radius is increased, and the sweep repeated until the shortest distance (radius) point has been identified. In one or more embodiments, multiple FGD parameters can be adjusted simultaneously at the closest favorable control region. By way of example, the FGD parameter values will include unit load and SO₂ inlet concentration; limestone inlet rates and tank water level and water inlet and exit rates that directly impact pH and density of the tank and spray solutions; tank temperature; gas inlet pressure; gas outlet pressure; flue gas temperature; etc. In addition to identifying the closest control variable region that allows for satisfying the performance goal, the controller also determines a sequence of control moves. A number of control moves may be required because the controller may be subject to constraints on how many parameters can be changed at once, how quickly they can be changed, and how they can be changed in coordination with other parameters that are also adjusted simultaneously, for example. The controller determines an initial control move. In a subsequent step, it communicates that control move to the FGD manipulatable controls, for example, through a control interface. After a suitable interval, preferably when the response to the setting manipulation operation is stable, the operating parameters and boiler and FGD outputs, i.e., indicators of actual boiler and FGD performance, are stored. Additionally, satisfaction of the performance goal is also measured and stored. In particular, the system may store information about whether the SO₂ level is satisfactory or has shown improvement. The control sequence is then repeated. In some embodiments, the identified FGD operating settings may not be reached because the performance goal or FGD operating conditions may change before the sequence of control moves selected by the controller for the previous performance goal can be implemented, initiating a new sequence of control moves for the FGD operation.

The stored FGD operating setting and FGD outputs, and the reinforcement generator's assessment of favorable and unfavorable conditions, are used on a periodic and settable basis, or as needed, as input to retrain controller. The regular retraining of controller allows it to adjust to the changing relationship between the FGD parameters and the resulting FGD output values.

Some embodiments of the present invention may incorporate an alternative FGD optimization system, with an alternate controller. The controller can be an indirect controller that uses a system model to determine the FGD operating parameters that are required to achieve a desired performance level for the FGD. The controller generally optimizes the FGD parameters to achieve and maintain the desired performance. In the FGD optimization system, the controller also communicates the FGD operating settings to FGD control interface. The system model is an internal representation of the FGD response resulting from changes in its control and state variables with the FGD operating parameters among the inputs, in addition to various state variables. In such embodiments, the controller learns to control the chemical removal process by first identifying and constructing a system model and then defining control algorithms based upon the system model. The system model can represent a committee of models. In various embodiments of the invention incorporating an indirect controller, the controller may use any number of model architectures and adaptation methods. Various implementation techniques described in conjunction with controller will also be applicable to model. In general, model predicts the performance of the boiler under different combinations of the control variables.

In various embodiments, the system model is a neural network, mass-energy balance model, genetic programming model, or other system model. Models can be developed using data about the actual performance of the FGD. For example, a neural network or genetic programming model can be trained using historical data about the operation of the boiler. A mass-energy balance model can be computed by applying first principles to historical or real-time data to generate equations that relate the performance of the FGD to the state of the FGD and the FGD operating parameters. Data that is collected during subsequent operation of the FGD can later be used to re-tune the system model when desired.

In an alternate embodiment, the controller is an indirect controller and uses a system model to determine a set of FGD control parameters for the set of subsystems in the FGD that are required to achieve or approximate as closely as possible a desired performance level of the FGD. In alternate embodiments, the controller can be a direct controller that determines the set of control parameters. In either type of embodiment, control parameters are determined as functions of the FGD performance goals, which are generally known or readily definable. In one embodiment, the controller uses a system model to evaluate the effects of different sets of control parameter levels under the current FGD operating conditions and determine one or more sets of control parameter levels that will satisfy the desired performance objective. The controller receives as input the current FGD state, including the current control parameter levels, and desired performance goals. As discussed above, the FGD operating conditions generally include limestone flow rates, water flow rates, etc. Control parameter levels in the FGD are not directly manipulated variables. Control parameters include, e.g., pH, tank level, density, header or line pressures, etc. Accordingly, it is contemplated that the corresponding FGD operating parameters that move the FGD to the desired state may be computed separately. The controller includes or is in communication with a processor that optimizes FGD operating parameters to maintain given control parameter levels. The controller transmits sets of control parameter levels to the processor. The processor optimizes the FGD operating parameters to maintain the received control parameter levels. The processor in turn is in communication with an FGD control interface and transmits the desired FGD operating parameters to the FGD control interface as necessary.

The controllers are, preferably, software and run the models also, preferably, software to perform the computations described herein, operable on a computer. The exact software is not a critical feature of the invention and one of ordinary skill in the art will be able to write various programs to perform these functions. The computer may include, e.g., data storage capacity, output devices, such as data ports, printers and monitors, and input devices, such as keyboards, and data ports. The computer may also include access to a database of historical information about the operation of the boiler. Processor is a similar computer designed to perform the processor computations described herein.

As referenced above, various components of the FGD optimization system could be integrated. For example, the FGD control interface, the processor, and the model-based controller could be integrated into a single computer; alternatively model-based controller and sootblower interface could be integrated into a single computer. The controllers may include an override or switching mechanism so that efficiency set points or FGD optimization parameters can be set directly, for example, by an operator, rather than by the model-based controller when desired.

While the present invention has been described with reference to preferred embodiments thereof, it will be apparent to those skilled in the art that modifications can be made and the invention can be practiced in other environments without departing from the spirit and scope of the invention, set forth in the accompanying claims.

1. A method for determining operating settings for an FGD unit in a boiler, comprising:
(a) receiving a performance objective for the FGD unit;
(b) receiving data indicating a current state of the FGD unit;
(c) using a controller to determine operating settings for the FGD unit to satisfy the performance objective for the FGD unit using the received performance objective for the FGD unit and the received data indicating the current state of the FGD unit; and
(d) outputting the operating settings to the FGD unit.

2. The method of claim 1 wherein step (c) comprises determining values for controllable parameters for the FGD unit and determining said operating settings from said values for said controllable parameters.

3. The method of claim 2 wherein said controllable parameters include reaction tank conditions and line pressures.

4. The method of claim 1 wherein said operating settings include one or more of limestone injector settings, mist eliminator wash lance settings, fan settings, reaction tank water level settings, tank mixer settings, and tank recycle spray pump settings.

5. The method of claim 1 wherein said performance objective comprises achieving a particular value or a range of values for one or more performance parameters or generally optimizing said one or more performance parameters.

6. The method of claim 1 wherein said performance objective includes maintaining at a given range of or generally optimizing SO₂ emissions, limestone consumption and/or power consumption by the FGD unit.

7. The method of claim 1 wherein the current state of the FGD unit is specified by data on controllable parameter conditions and operating conditions of the FGD unit.

8. The method of claim 1 further comprising using a system model of the boiler to determine the performance objective for the FGD unit.

9. The method of claim 1 wherein step (c) comprises using a controller with a system model that relates controllable parameters of the FGD unit to the performance of the FGD unit.

10. The method of claim 9 wherein said system model comprises a neural network, a mass-energy balance model, or a genetically programmed model.

11. The method of claim 1 wherein said controller is an adaptive controller.

12. The method of claim 1 wherein said controller is an indirect controller.

13. The method of claim 1 wherein said controller is a direct controller.

14. The method of claim 1 further comprising retraining said controller periodically or as needed.

15. The method of claim 1 wherein step (c) comprises determining a sequence of control moves for said operating settings to satisfy the performance objective for the FGD unit.

16. A system for determining operating settings for an FGD unit in a boiler, comprising:
a control system input for receiving a performance objective for the FGD unit, and data indicating a current state of the FGD unit;
a control system for determining operating settings for the FGD unit to satisfy the performance objective for the FGD unit using the received performance objective for the FGD unit and the received data indicating the current state of the FGD unit; and
a control system output for outputting the operating settings to the FGD unit.

17. The system of claim 16 wherein the control system determines values for controllable parameters for the FGD unit and determines said operating settings from said values for said controllable parameters.

18. The system of claim 17 wherein said controllable parameters include reaction tank conditions and line pressures.

19. The system of claim 16 wherein said operating settings include one or more of limestone injector settings, mist eliminator wash lance settings, fan settings, reaction tank water level settings, tank mixer settings, and tank recycle spray pump settings.

20. The system of claim 16 wherein said performance objective comprises achieving a particular value or a range of values for one or more performance parameters or generally optimizing said one or more performance parameters.

21. The system of claim 16 wherein said performance objective includes maintaining at a given range of or generally optimizing SO₂ emissions, limestone consumption and/or power consumption by the FGD unit.

22. The system of claim 16 wherein the current state of the FGD unit is specified by data on controllable parameter conditions and operating conditions of the FGD unit.

23. The system of claim 16 wherein said control system includes a system model of the boiler to determine the performance objective for the FGD unit.

24. The system of claim 16 wherein said control system includes a system model that relates controllable parameters of the FGD unit to the performance of the FGD unit.

25. The system of claim 24 wherein said system model comprises a neural network, a mass-energy balance model, or a genetically programmed model.

26. The system of claim 16 wherein said control system includes an adaptive controller.

27. The system of claim 16 wherein said control system includes an indirect controller.

28. The system of claim 16 wherein said control system includes a direct controller.

29. The system of claim 16 wherein said control system includes a controller that is retrained periodically or as needed.

30. The system of claim 16 wherein said controller determines a sequence of control moves for said operating settings to satisfy the performance objective for the FGD unit.

31. A computer program product, residing on a computer readable medium, for use in determining operating settings for an FGD unit in a boiler, the computer program product comprising instructions for causing a computer to:
receive a performance objective for the FGD unit;
receive data indicating a current state of the FGD unit;
determine operating settings for the FGD unit to satisfy the performance objective for the FGD unit using the received performance objective for the FGD unit and the received data indicating the current state of the FGD unit; and
output the operating settings to the FGD unit.

32. The computer program product of claim 31 wherein operating settings are determined by determining values for controllable parameters for the FGD unit and determining said operating settings from said values for said controllable parameters.

33. The computer program product of claim 32 wherein said controllable parameters include reaction tank conditions and line pressures.

34. The computer program product of claim 31 wherein said operating settings include one or more of limestone injector settings, mist eliminator wash lance settings, fan settings, reaction tank water level settings, tank mixer settings, and tank recycle spray pump settings.

35. The computer program product of claim 31 wherein said performance objective comprises achieving a particular value or a range of values for one or more performance parameters or generally optimizing said one or more performance parameters.

36. The computer program product of claim 31 wherein said performance objective includes maintaining at a given range of or generally optimizing SO₂ emissions, limestone consumption and/or power consumption by the FGD unit.

37. The computer program product of claim 31 wherein the current state of the FGD unit is specified by data on controllable parameter conditions and operating conditions of the FGD unit.

38. The computer program product of claim 31 further comprising instructions for causing the computer to use a system model of the boiler to determine the performance objective for the FGD unit.

39. The computer program product of claim 31 wherein instructions for causing the computer to determine operating settings comprises a controller with a system model that relates controllable parameters of the FGD unit to the performance of the FGD unit.

40. The computer program product of claim 39 wherein said system model comprises a neural network, a mass-energy balance model, or a genetically programmed model.

41. The computer program product of claim 31 wherein instructions for causing the computer to determine operating settings comprises instructions for causing the computer to determine a sequence of control moves for said operating settings to satisfy the performance objective for the FGD unit.
